(19) United States
(12) Patent Application Publication
(10) Pub. No.: US 2004/0263497 A1
(43) Pub. Date: Dec. 30, 2004

(54) Low resolution acquisition method and device for controlling a display screen

(76) Inventors: Thierry Leroux, Ouistreham (FR); Veronique Gibour, Hamars (FR)

Correspondence Address: PEARNE & GORDON LLP, 1801 EAST 9TH STREET, SUITE 1200, CLEVELAND, OH, 44114-3108, US

(21) Appl. No.: 10/496,943

(22) PCT Filed: Dec. 16, 2002
(86) PCT No.: PCT/FR02/04370

(30) Foreign Application Priority Data
Dec. 17, 2001 (FR) 01/16303

(51) Int. Cl. G09G 5/00

(52) U.S. Cl. 345/204

(57) ABSTRACT

The invention relates to a device and a control process for a display screen with:

means (14) of checking the display screen (E) so as to display a test pattern on the screen,

means (18) of forming an image of the test pattern on an electronic camera (12) with a resolution less than the resolution of the display screen,

means (10, 20, 22) of offsetting the image of the test pattern on the camera, and

means (14) of analyzing several offset images output by the camera to localize defective pixels on the display screen.

### TECHNICAL FIELD

This invention relates to a device and process for checking display screens. It is intended for checking screens, particularly to determine the number of defective pixels and possibly to localize these pixels. The invention is applicable to any type of screen capable of displaying a test pattern or a set of periodic or pseudo-periodic test patterns.

The invention is used particularly in quality control applications. The destination or the commercial value of a display screen is decided upon based on knowledge of the defective pixels on the display screen. The location of the defective pixels is also a means of repairing the screen in some cases, or correcting the screen manufacturing process.

### STATE OF PRIOR ART

The state of the art is illustrated by documents (1) to (7), which are defined in the complete references at the end of this description.

As mentioned above, one important check parameter for display screens is whether or not there are any defective pixels, and their location on the screen. The presence of any defects in display screens for some particular fields such as aerial monitoring or medical imagery could make them unusable. Furthermore, detection of a systematic defect on a series of screens manufactured one after the other may be the sign of an imperfection affecting a tool such as a silk screen printing mask or a photolithography mask.

Finally, some screens are provided with redundant check circuits and defects can be corrected to a certain extent. However, a defect cannot be corrected unless its exact location is known.

Some defects that can affect a display screen usually include “abnormally on” and “abnormally off” defects. Abnormally on defects are pixels on the screen that are in the “on” display state even when no illumination command is applied to them. Abnormally off defects are pixels on the screen which are in the “off” display state, despite the fact that they are energized by a control signal.

For some screens, it is accessorily possible to transform abnormally on defects into abnormally off defects, since abnormally off defects are usually considered to be less annoying.

The location of screen defects may generally take place by imposing a given display state on the screen and comparing the display state actually obtained with the required display state. This operation may take place by automatically analyzing one or several screen images output by an electronic camera. An electronic camera is a camera with a set of light sensitive pixels that output an electronic signal as a function of the light received by the pixels. The electronic signal can then be used in calculation equipment. For example, the camera may be a CCD (Charge Coupled Device) camera.

It is easy to understand that in order to check a screen with a given resolution, it is useful to have a camera with a resolution at least the same or even better. This condition is necessary to exactly localize the defects in the screen image.

However, considering the fact that the resolution of screens is continuously getting better and therefore check cameras also need to have a better resolution, the cost of test equipment is becoming very high.

Some work has been done to obtain higher definition images from low resolution plates. For example documents (1) to (3) mentioned above provide information in this respect. These techniques are called “multichannel super-resolution” and in particularly have attempted to solve noise sensitivity problems and/or problems with operating conditions to the detriment of the precision of the result. Furthermore, an improvement of the robustness of the processing has increased the complexity and the difficulty. Thus, these techniques are not really appropriate for checking display screens, and particularly for checking them in series.

Document (4) describes a check device in which the camera definition may be chosen to be less than the definition of the screen to be checked by a factor of 1.5, but there must be a fixed size ratio between the pixels of the screens to be checked and the camera pixels. This fixed size ratio is very constraining in positioning of the screen, and also imposes the use of a relatively high definition camera and an excellent quality optics (very low distortion).

Document (5) describes an interpolation checking device in which a large number of test patterns are displayed to test a screen from a single acquisition. Apart from the fact that the analysis time becomes very long due to the large number of test patterns to be displayed (25 to 49), the device has the disadvantage that it cannot detect abnormally on defects and that it can be disturbed by these defects.

Document (6) describes a check device in which a camera with a definition higher than the definition of the tested screen is used. The cost price of such equipment is very high.

### PRESENTATION OF THE INVENTION

The purpose of the invention is to propose a process and a device for checking display screens that do not have the difficulties and limitations of the processes and devices mentioned above.

One particular purpose is to propose a process and a device for using a camera with a resolution significantly lower than the resolution of the screen to be checked.

Another purpose is to enable continuous and automatic checking of screens at the exit from production, in order to evaluate their characteristics.

Yet another purpose is to be able to quickly and precisely localize abnormally off defects as well as abnormally on defects.

Another purpose is to propose a process that is very stable and therefore not very sensitive to operating conditions.

More precisely, the purpose of the invention in order to achieve these objectives is a process for checking a display screen comprising the following steps:

a) the screen to be checked is controlled so as to display at least one test pattern with at least one spatial period P,

b) acquisition of a sequence of simple images of the test pattern using an electronic camera with a definition lower than the definition of the screen to be checked, the successive simple images being offset from each other,

c) construction of an over sampled image (S) of the test pattern starting from the simple images,

d) the calculation of some spectral components of the over sampled image using a first Fourier transform,

e) compensation of spectral alterations resulting from the previous steps by deletion and/or weighting of spectral components,

f) calculation of spectral components of a new image of the test pattern using a second Fourier transform of the spectral components resulting from step e),

g) the analysis of the new image.

The new image used for the analysis then has a resolution better than the resolution of simple images.

As mentioned above, an electronic camera means a camera such as a CCD camera that outputs an electronic signal that can be processed by a computer. Note that steps c) to g) in the process are preferably executed in a computer, for example by a program executed in a microcomputer.

The process according to the invention is capable not only of supplying a final image with a resolution better than the resolution of the camera that can be used to evaluate the display screen, but also to sort which of the acquired information applies to the displayed test pattern and which are the result of parasite phenomena.

An over sampled image of the test pattern can be constructed by interlacing simple images. It is used to form an over sampled image that contains more information than each simple image initially captured by the camera. In both cases, the over sampled image is formed from more pixels than the simple images taken alone.

The spatial sampling pitch τₛ of the over sampled image is actually finer than the sampling pitch of the camera pixels. The relative sampling pitch of the camera, for which the pixels are assumed to be square for simplification purposes, is denoted τ_{CCD} in the remainder of the text.

It should be mentioned that the size of the camera pixel (T_{R}) is not necessarily the same as the distance between two pixels (CCD sampling pitch or CDD period denoted τ_{CCD}). This occurs when the pixel filling ratio is less than 100%, in other words when there are dead areas that are not light sensitive between the pixels of the camera. This case occurs particularly in the case of CCD cameras with an anti-blooming device.

Interlacing may consist simply of placing pixels from different successive images acquired using the camera between and adjacent to each other. On the other hand, construction of the over sampled image from the image of simple pixels may be more complex. Each pixel in the over sampled image may be built from one or several pixels of simple images, with a determined weighting. For example, in order to improve the precision of the final image obtained at the end of the process, the spatial pitch τₛ of the over sampled image can be adjusted by calculation during step c) such that the product Nτₛ is a multiple of the spatial period of the test pattern displayed on the screen (τₛN=kP). In other words, the spatial pitch τₛ is adjusted such that a spectrum period is sampled by an integer number of points. The value N corresponds to the number of spatial samples selected in the over sampled image to make the first Fourier transform. Although a single spatial pitch is considered here, different pitches may exist for different directions in space.

In one special interlacing case, the spatial pitch τₛ may be defined as being the ratio of the period of camera pixels (τ_{CCD}) (in a considered direction) to the number of simple images in the sequence of images (in the same direction).

The choice of pixels in the initial images selected for interlacing, and the weighting of the calculation of the pixels of the over sampled image, may also be adapted to introduce an offset, a rotation and/or a modification of the sampling pitch (τₛ) of the over sampled image. Thus for example, weighting is a means of correcting the spatial sampling pitch τₛ of the over sampled image or of correcting centering or parallelism defects of the image of the screen formed on the camera.

Thus, registration of the over sampled image can correct any alignment defects between the screen to be checked and the camera. More precisely, a calculated correction can be made to substantially align the center of an image on the screen to be checked with the center of the camera and/or to align at least one edge of the image with an edge of the camera and/or to correct or compensate for the optical distortion of an optical system used with the camera. The above operations may be facilitated by a deliberate simulation of several defective pixels with known coordinates on the screen to form a registration system or registration mark. For example, abnormally off defects may be added in the test pattern. A registration system may also be formed starting from the abnormally on pixels that are deliberately displayed.

Registration and alignment of the image are operations which are not essential, like other operations mentioned in the remainder of the text, but do help to obtain a better quality final image for precisely determining the positions of defects.

Note that registration by translation may take place not only during the calculation of the over sampled image, but also from spectral components of the image. In this case, the process may include control of pixels on the screen to simulate defects on a row and/or column in the test pattern, and to modify the phase of spectral components so as to make the phase of the recorded spectrum for the said row and/or column symmetric about a value ½P.

Note that the registration operations mentioned above are not critical for use of the process. However, registration can reduce the spatial extent of a defect on the new image obtained after step f) in the process.

Other measures may be taken to improve the precision of the location of defects on the new image. For example, either the first or the second Fourier transform could be made in an adapted manner by adjusting the spectral sampling pitch as a function of the spatial period P of the test pattern. The spectral sampling pitch is adjusted so that a spectral period is a multiple of the spectral sampling pitch. This improvement is unnecessary if the spectral pitch has already been adapted by adjustment of τₛ during construction of the over sampled image.

Minimum spreading of the information is obtained by calculating the samples of the second Fourier transform, preferably an inverse Fourier transform, for points of the screen that may coincide with pixels that may or may not be on.

Preferably, the spectral pitch

$$( {τ}_{f} = \frac{1}{N {τ}_{s}} )$$

is adjusted such that the product Nτₛ is an exact multiple of the spatial period P of the test pattern, where τₛ is the spatial sampling pitch of the over sampled image.

Note that in the special case in which the over sampled image is the result of interlacing taking account of all pixels in simple images acquired by the camera, the spatial resolution of the over sampled image is defined simply as the ratio of the period of camera pixels to the number of images in the sequence of images.

In this description, it will be considered that the camera pixels are square. If the pixels are rectangular or another shape, then the dimensions of the pixels in the offset direction(s) of the successive images can be taken into account.

Another measure, that may also be chosen to improve the sharpness of the new image obtained after step f), consists of artificially creating spectral high order harmonics before this step. This can be done by replicating spectral components obtained at the end of step e). For a test pattern with period P, the spectral components are replicated a number of times preferably equal to P.

For optimal information processing, the spatial period(s) of the test pattern displayed on the screen can also be determined as a function of the size of the camera pixels. For example, a test pattern can be displayed on the screen with periods Pₓ and P_{y} along the two directions x and y, such that:

$$\frac{1}{{T}_{Rx}} - {ϵ}_{x} > \frac{1}{2 Px}$$

$$\frac{1}{{T}_{Ry}} - {ϵ}_{y} > \frac{1}{2 Py}$$

In these expressions, the terms T_{RX} and T_{RY} represent the dimensions of an integration window for a camera pixel, and εₓ and ε_{y} are small safety factors.

When the test pattern is displayed by periodically switching pixels on, and when the conditions required to adapt the calculation of spectral samples as a function of the spatial period of the test pattern are satisfied as mentioned above, and when the registrations are correctly compensated, reproduction of the abnormally off defects in the new image obtained at the end of the process gives the best sharpness. Abnormally off defects are detected on a row or a column of the test pattern formed by the on pixels. Therefore, the location of these defects occurs within the period for which the calculations, and particularly the Fourier transform calculations, are optimized. Abnormally off defects are thus reproduced with the best possible sharpness in the new obtained image.

Still assuming an adaptation of the calculation of spectral samples at the period of the test pattern, the processing applied for abnormally on defects that are offset from the test pattern is not as optimized. The abnormally on defect also has spatial spreading in the new image which is greater than spatial spreading for abnormally off defects.

Spatial spreading may be reduced by recalculating the precise position of abnormally on defects from a center of gravity combination of two or more adjacent pixels in the new image, for which the intensity exceeds a threshold at which they are considered to be pixels resulting from such a defect.

A center of gravity calculation can also take place for abnormally off pixels if the calculation of the samples is not adapted to the period of the test pattern and/or other registration operations are not done or are not optimized. In this case, their spatial spreading is reduced by a calculation taking account of pixels for which the intensity exceeds a determined threshold by smaller values.

A reduction in spatial spreading of the defects in the new image can also be obtained by varying the phase of spectral components corresponding to these defects. The process can then include the following additional operations, particularly for abnormally on pixels:

i) selection of a region in the new image surrounding a defective pixel,

ii) the calculation of spectral components in this region using a Fourier transform,

iii) adjustment of spectral components by adding a phase correction term tending to make the phase symmetric for the selected region,

iv) the calculation of new spatial components using a Fourier transform, preferably an inverse transform, to form a new image of the region,

v) creation of coordinates of the defect starting from the new image of the region.

Step iii) mentioned above may in particular include adjustment of the phase by a value u=kπ/P, where k is a natural integer, and iteration of steps i) to iv) until a minimum spatial extension of the defect is obtained in the new image of the region.

The invention also relates to a checking device in which the process described above may be used. The device comprises:

means of controlling the display screen so as to display a test pattern on the screen,

means of forming an image of the test pattern on an electronic camera with a resolution lower than the resolution of the display screen,

means of offsetting the image of the test pattern on the camera, and

means of analyzing several offset images output by the camera to localize defective pixels on the display screen.

Other advantages and specificities of the invention will be understood more clearly from the following description given with reference to the figures in the attached drawings. This description is given for illustrative purposes and is in no way limitative.

### BRIEF DESCRIPTION OF THE FIGURES

FIG. 1 is a simplified diagrammatic representation of a device according to the invention.

FIGS. 2 to 4 are diagrammatic representations of parts of a screen to be checked and indicate the different ratios between the size of the pixels in an image capture camera, and a period of a test pattern displayed on the screen.

FIGS. 5 to 9 are diagrammatic representations of parts of a screen to be checked, and illustrate offsets of the pictures.

FIG. 10 illustrates the construction of an over sampled image starting from simple images.

FIG. 11 is a representation at an arbitrary scale of a spectrum corresponding to a periodic test pattern.

FIG. 12 is a diagrammatic representation of constraints for the registration and alignment of the screen image with respect to the camera.

### DETAILED DESCRIPTION OF EMBODIMENTS OF THE INVENTION

In the following description, identical, similar or equivalent parts of the different figures are marked with the same reference symbols to facilitate comparison between figures. Furthermore, not all elements are shown at the same scale in order to make the figures easy to read.

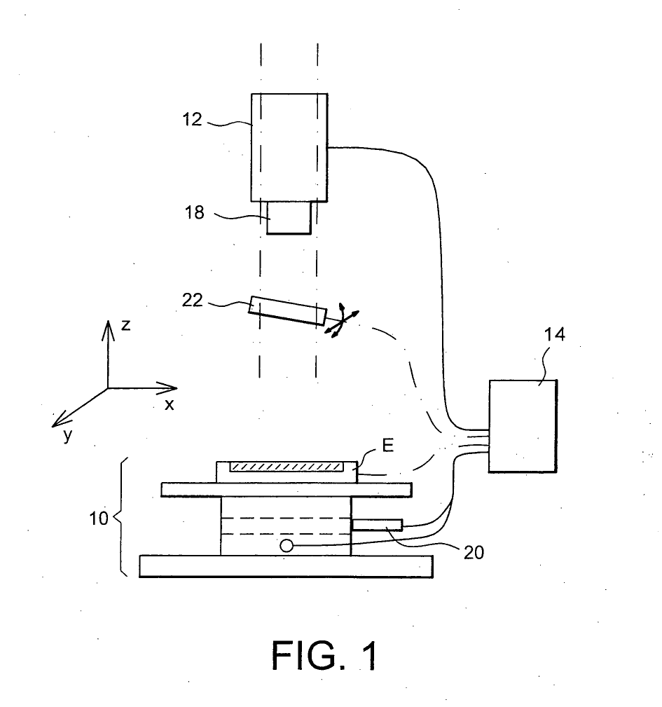

FIG. 1 shows a device according to the invention. Essentially, this device comprises a reception table 10 for a display screen E, a camera 12 and a microcomputer 14 connected to the camera to interpret images supplied by the camera. For example, the camera 12 may be a CCD type camera, cooled in order to limit noise. The resolution of the camera may be less than the resolution of the screen E, which means that the total number of pixels may be less than the number of screen pixels. The camera is installed free to move along a vertical rail 16 to enable adjustment of the distance from the camera to the screen. It is also provided with an objective 18 used to adjust the focus and possibly the magnification ratio of the image on the screen. The objective 18 is used to form a screen image on the camera, or a test pattern displayed on the screen.

The device comprises one or several separate means to enable taking a series of slightly offset views of the screen E. These means may be means of translation of the table in a plane perpendicular to the optical axis of the camera, so as to enable relative movement of the table and the camera between each picture. The offsets and movements of the table 10 along the x axis and the y axis may be controlled by control jacks 20 controlled by the computer 14. Larger amplitude movements can also be made manually.

The offset between the successive pictures along the x and y axes can thus be produced by means of a transparent strip or transparent plate 22 with parallel faces installed free to pivot in the field of the camera. Rotation of the strip causes an offset of the screen image on the camera. The strip 22 is rotated about at least one of the two axes x and y by motor driven means, not shown, controlled by the computer 14. It is also possible to use two separate strips each free to move about a different axis of rotation.

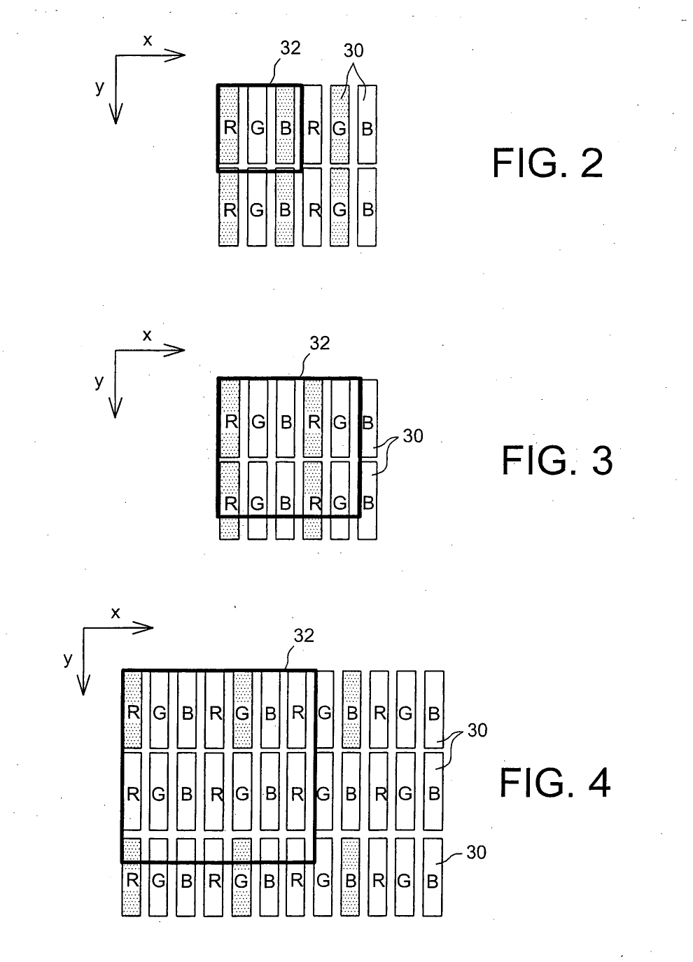

As mentioned above, the screen is controlled to display a periodic test pattern on it, for example, by a periodic display of “on” pixels. The screen may be controlled by the computer 14 or by any other device which may or may not be integrated into the monitor. Although the invention is perfectly applicable to black and white or monochrome screens, or color screens with architectures other than the “band” type, FIGS. 2 to 4 each shows part of a color screen with band structure. The pixels 30, corresponding to red, green and blue colors, are indicated by the letters R, G and B respectively.

The pixels 30 have different dimensions along two directions marked with arrows x and y in the figures. Furthermore, it is seen that the red, green and blue pixels are arranged in corresponding columns, along the y direction. However, it should be noted that this arrangement is not essential. Any other orthogonal or other arrangement of pixels could be checked, provided that the screen enables the display of at least one periodic or pseudo-periodic test pattern.

Note also that the shapes of the pixels may be rectangular, square, triangular or other.

Shading of the pixels in the figures enables identification of pixels that are energized so that they can be displayed “on”. In the rest of this text, they will simply be denoted as “on pixels”, in contrast to “off pixels”. This does not prejudge whether or not there are any “abnormally off” pixels among the on pixels. In the same way there may accidentally be “abnormally on” pixels among the off pixels, in other words pixels that are not energized.

Furthermore, a square 32 in FIGS. 2 to 4 shows an example of a region of the screen seen by a camera pixel. Throughout the rest of the text, this type of region is referred to as a camera pixel, although this is a misnomer. A single pixel 32 is shown for simplification reasons.

FIG. 2 shows a situation in which the test pattern displayed on the screen has a period Px=2 along the x axis and a period Py=1 along the y axis. The relative size of the screen image and the camera pixel is such that the camera pixel 32 integrates light information originating from several screen pixels 30. This is due to the fact that the resolution of the camera is less than the resolution of the screen. In the example shown in FIG. 2, each camera pixel 32 “sees” about three screen pixels. Note that the camera pixels are not necessarily adjacent. They may be separated by borders not sensitive to light. The loss of information due to the borders may be perfectly compensated by an increase in the number of screen pictures.

FIG. 3 shows another situation in which the periods of the test pattern displayed on the screen are Px=3 and Py=1. Each camera pixel 32 includes all or some of the light from the 12 screen pixels. It may be observed in FIG. 3 that the size of the camera pixels is not necessarily coincident with a multiple of the size of the screen pixels. Thus the contribution of an individual screen pixel may be variable.

A final example is given in FIG. 4 in which the periods of the test pattern are Px=4 and Py=2 respectively, and in which each camera pixel “sees” 24 screen pixels.

An optimum construction of the final image used for the screen analysis takes place when the number of on pixels 30 that are seen by a camera pixel 32 does not exceed 4. This is the case in each of the examples illustrated. However, the process may be used with a larger number of on pixels.

In one preferred embodiment of the invention, particularly suitable for color screens with a band structure, the selected test pattern is as shown in FIG. 3. A period Px=3 and Py=1 is obtained simply by controlling all red pixels, and then all green pixels and then all blue pixels in sequence.

For marking of the pixels that are abnormally on and abnormally off, it may be useful to repeat the process several times with different test patterns so that each screen pixel can be tested at least once in each of its two states (on and off). Thus, when the period of the test pattern is more than 2 in a given direction, each pixel is tested once in its on state and (P−1) times in its off state.

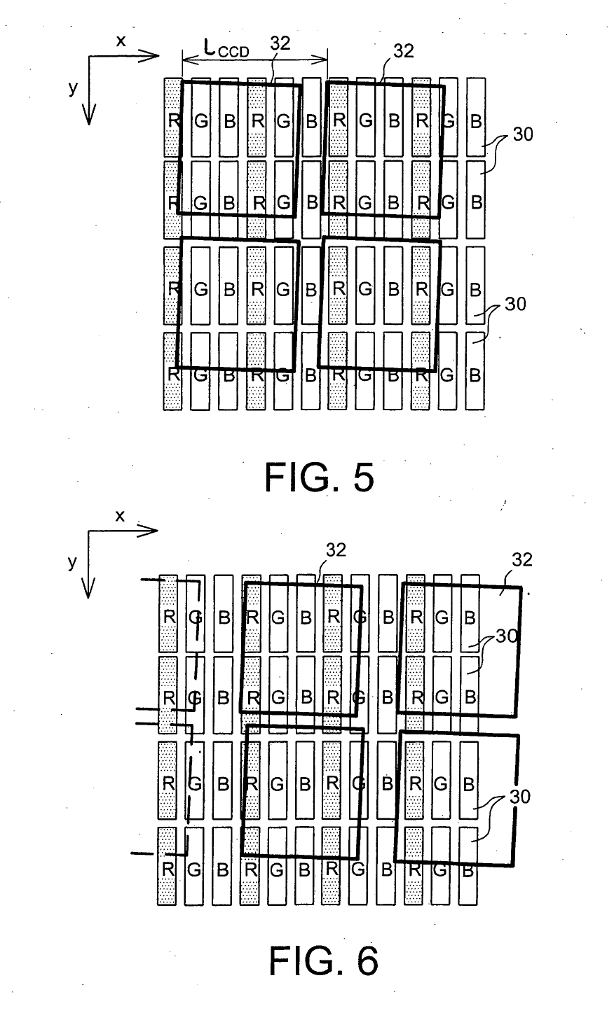

As mentioned above, the process comprises the acquisition of several images each with an offset. Although the offset may a priori be greater than the size of a camera pixel, it is preferable to make small offsets, less than the size of a camera pixel, particularly to facilitate the subsequent interlacing step. More generally, the offset may be chosen so that it is different from the relative distance between two camera pixels. The offset between successive images may be made along any direction. However, once again, it is preferable to use an offset along the x or the y direction parallel to the arrangements of the screen pixels. FIGS. 5 to 9 described below illustrate the acquisition of several images. Unlike the previous figures, several camera pixels 32 are shown in these figures.

FIGS. 5 and 6 show an offset, approximately along the x axis, between two successive images captured by the camera. The images are taken for a screen on which a test pattern conform with FIG. 3 is displayed. The pitch of the camera pixels 32, expressed as a function of the screen pixels, or more precisely the screen image, is τ_{CCD}=5.5. The offset between the two successive images is chosen to be equal to half of the pitch size of the camera pixels, so that a maximum spatial pitch τ_{s,x} equal to τ_{s,x}=5.5/2=2.75 can be obtained in the x direction.

In this case, it is considered that the over sampling ratio is equal to 2.

FIGS. 7, 8 and 9 give a second example in which the pitch of the pixels is still equal to 5.5 and the over sampling rate is equal to 3. The spatial pitch along the x direction is then τ_{s,x}=1.83.

The simple image acquisition operation is followed by the operation to construct the over sampled image. This consists basically of simply inserting pixels from previously captured simple images adjacent to each other. Interlacing may be much more complex and each pixel in the over sampled image may be rebuilt starting from a single pixel or several pixels from simple images. Rotations, offsets, dimension ratios or other corrections may thus be added to the over sampled image. In particular, the spatial pitch τₛ of the over sampled image may be modified. The index x is eliminated in this case since the spatial pitch is not necessarily along the x direction.

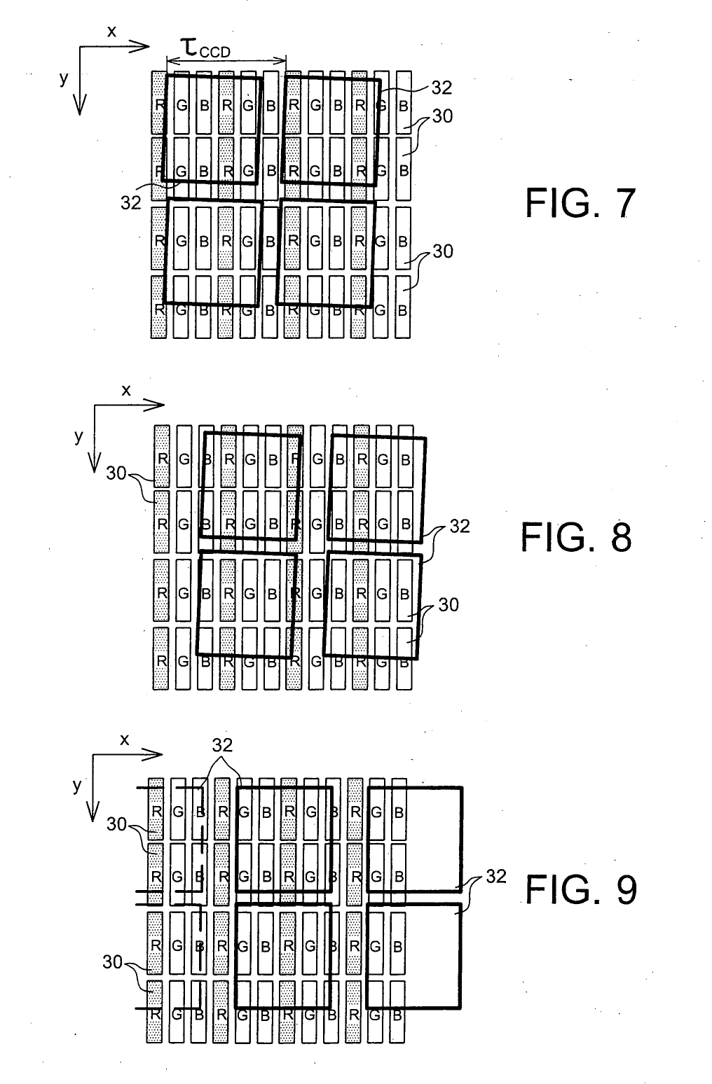

A particularly simple example of interlacing is shown in FIG. 10. It is considered that there are eight screen images available made by using three offsets along the x direction and one offset along the y direction. The images are marked with references indicating the rows and columns in the form I. (τ_{s,x}; τ_{s,y}) where τ_{s,x}, and τ_{s,y} indicate offsets along the x axis and the y axis respectively. The numbers τ_{s,x} and τ_{s,y} indicate the number of offsets made along each direction. In one special case, τ_{s,x}=4 and τ_{s,y}=2. Each of the eight images has a low definition of 4×3 pixels.

An over sampled image with a higher resolution is created with 16×6 pixels. In this example, pixel (0, 0) in the over sampled image is given by pixel (0, 0) of image I(0, 0), pixel (0, 1) in the over sampled image is given by pixel (0, 01) of image I(0, 1), pixel (1, 0) of the over sampled image is given by pixel (0, 0) in image I(1, 0), pixel (T_{s,y}, 0) in the over sampled image is given by pixel (1, 0) of image I(0, 0), pixel (0, T_{s,x}) of the over sampled image is given by pixel (0,1) of image I (0, 0).

The over sampled image may also be constructed using a weighted interlacing. For example, pixel (0, 0) in the over sampled image S may be derived from a linear combination of the contribution of pixels (0, 0) of the initial images I(0, 0), I(0, 1) and I(1, 0).

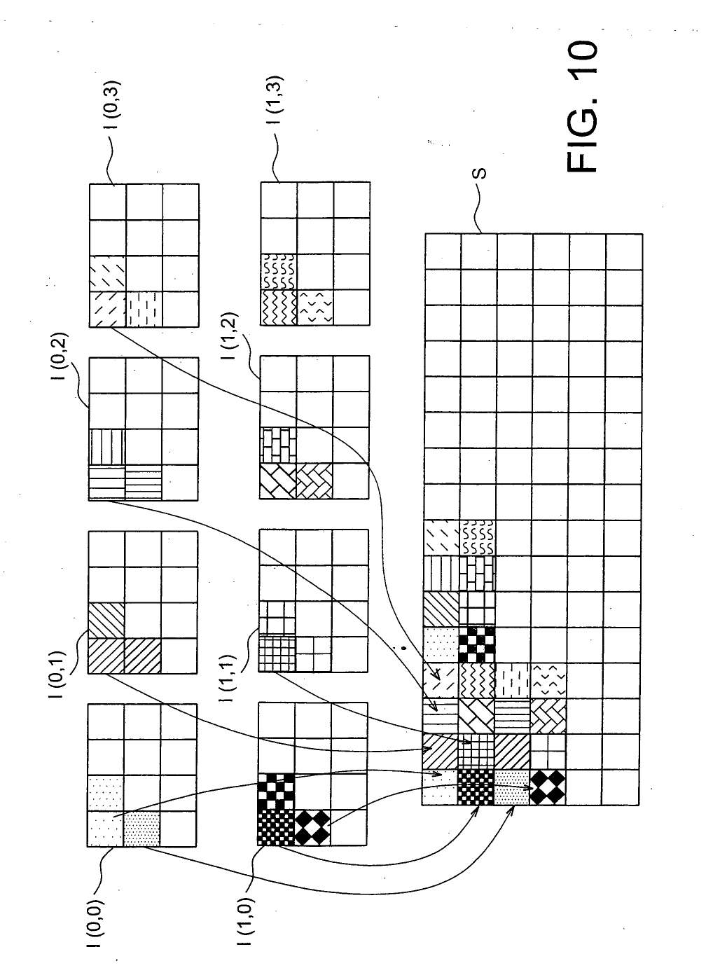

The over sampled image is used to produce the spectrum by Fourier transform. Although the calculation is a discrete calculation on discrete values corresponding to the pixels of the over sampled image, FIG. 11 shows a simplified representation of a continuous spectrum with symmetry about the axis at 0.

More precisely, FIG. 11 shows an ideal continuous spectrum F corresponding to a periodic test pattern displayed on a screen without any defects. The spectrum F shows a periodic sequence of the main dominant spikes, characteristic of the conversion of a periodic image. However, a spectrum conform with FIG. 11 is not obtained by the Fourier transform of the real image of a screen. The spectrum is affected by a number of parasite phenomena.

A first parasite phenomenon, known in itself, is spectral folding due to the periodic nature of the test pattern and the acquisition system (camera). It results in a beating phenomenon characterized by the appearance of parasite rays in the spectrum centered on a fundamental or harmonic frequency of 1/τₛ. The parasite rays, not shown in the figure for reasons of clarity, may be eliminated by an adapted selective filtering. Since the position of the parasite rays is dictated by the pitch of the displayed test pattern, their occurrence is predictable and it is easy to eliminate them. The parasite rays actually correspond to frequencies f such that:

$$f = \frac{k}{{τ}_{s}} - \frac{n}{P}$$

In this expression, k and n denote natural integers and P denotes the spatial frequency of the test pattern. The spatial frequency is only considered along a single direction to simplify the illustration.

Another phenomenon affecting the spectrum is modulation of the spectrum due to the necessarily non zero width of the display screen pixels. This phenomenon may be characterized by a cardinal sine type transfer function indicated by reference B in FIG. 11. Another transfer function C, also in the form of a cardinal sine (sinx/x) shows a low pass filter function induced by the camera which also has non zero size pixels. Other transfer functions, not shown, characterize the influence of the acquisition system as a whole on the spectrum, particularly including the optical equipment. The influence of the acquisition system is particularly marked for high frequency components of the spectrum.

The spectrum actually obtained is the result of multiplying the perfect spectrum F and the different transfer functions (particularly C and B).

The alterations may be compensated from transfer functions that are known, or that may be determined in advance for the acquisition system. The function F is then reproduced at least partly by dividing the real spectrum obtained using a Fourier transform, by the corresponding values of the transfer functions (B and C in the example in FIG. 11).

Compensation is not made for the entire spectrum, but is preferably limited to components of the spectrum corresponding to the smallest spectral period of the test pattern centered at 0 (zero). This part of the spectrum which is the least degraded, may be selected by a windowing operation. Windowing is a means of selecting a part I_{P} of the spectrum indicated in FIG. 11, which is preferably located before the first zero of a transfer function, to avoid amplification of parasite phenomena during the division mentioned above. For example, the selected part corresponds to a spectral period centered at zero.

A new image in the spatial domain is obtained by a second Fourier transform carried out after compensation of the alterations mentioned above. The second Fourier transform may be made on the part of the spectrum selected by windowing, or possibly on a spectrum rebuilt by replication of the pattern corresponding to the window. Replication consists of creating spectral harmonics. The number of replications is preferably equal to the pitch P of the test pattern.

The new image may then be used to identify defective pixels on the screen.

The first Fourier transform takes place on a number of samples N that depend on the previously built over sampled image. The over sampling pitch τₛ of the over sampled image depends essentially on the pitch τ_{CCD} of the camera pixels and the number n of images taken in at least one offset direction. The result is thus τₛ=τ_{CCD}/n.

The discrete Fourier transform gives a number N of spectral samples distributed with a frequency of 0 to 1/τₛ. The spectral pitch is then τ_{f}=1/(Nτₛ). The information contained in the image is restored optimally, in other words with a minimum spatial (or spectral) spreading when one of the first and second Fourier transforms is made with a sampling pitch adapted to the sampling pitch of the period of the test pattern.

For example, this is equivalent to making a second Fourier transform with an adapted spectral pitch, such that τ_{f}=1/(kP) where k is a natural integer. Adaptation of the spectral pitch is equivalent to choosing N and τₛ such that 1/(Nτₛ)=1/(kP).

If this condition is not satisfied, the coefficients of the Fourier transform can be modified by replacing the value of N in the Fourier transform by a modified value respecting the condition. The value τₛ of the image “pitch” can also be modified in the spatial domain. This modification can take place very simply by modifying the calculation of the over sampled image.

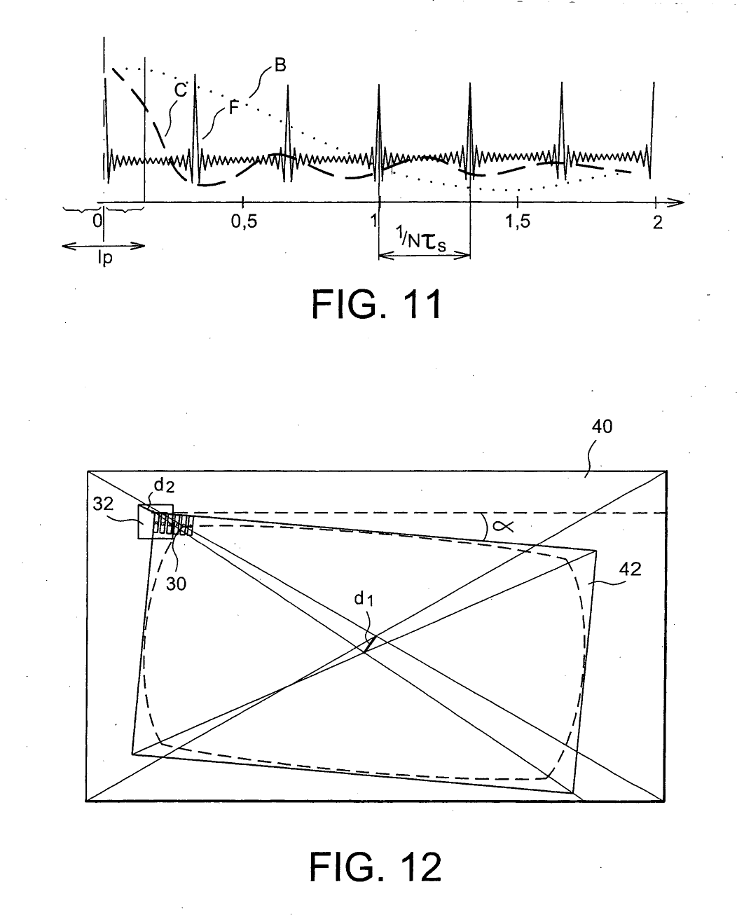

The image analysis may be optimized when the screen is in a determined position with respect to the camera, when the initial images are acquired. Ideally, the relative position of the screen and the camera is chosen such that the image of the center of the screen coincides approximately with the center of the camera pixels matrix. Furthermore, the position is also ideally chosen to make the edges of the screen image and the edges of the camera matrix parallel. Different defects in the positioning of the screen are shown in FIG. 12. FIG. 12 shows the sensitive surface 40 of a camera and a screen image 42, formed on the sensitive surface. Reference d₁ indicates an offset between the centers of the image and the sensitive surface of the camera. The reference d₂ indicates an offset between the first corner pixel 30 of the screen image and a camera pixel 32. The term α indicates an inter frame rotation angle marking a parallelism defect. To simplify the figure, only a few pixels 30 on the screen image and only one camera pixel 32 are shown. And furthermore, the size of these pixels is exaggerated. Finally, FIG. 12 shows another defect in the reconstitution of the image that presents a barrel shaped deformation due to the optics. This is shown in dashed lines.

Positioning defects do not prevent the screen from being checked, but they may affect the quality of the final image obtained. When the screen is located on a moving reception table under the camera, position adjustments may be made directly using the jacks 20 described with reference to FIG. 1.

However, screen positioning operations under the camera take up a large amount of time for check applications at the exit from the production system where a large number of screens have to be examined.

An automatic correction may then be made during processing of the images. The inter frame rotation angle, the image distortion and possibly offsets d₁ and d₂ may be corrected during construction of the over sampled image. Offsets may be compensated by a corresponding offset of the pixels in simple images used to calculate a pixel of the over sampled image. The correction is facilitated by the deliberate display of several abnormally off or abnormally on defects on the screen. These then form a positioning system or positioning mark.

For a correction to the registration in the spectral domain, it may also be necessary to distribute deliberately on defects on a row and a column on the screen, and to introduce a phase correction on the spectrum corresponding to this row and this column. The phase correction term is adjusted to make the phase of the spectrum symmetrical about the half period P of the test pattern displayed on the screen.

As mentioned above, the final image may then be used to detect abnormally on pixels among the off pixels or to detect abnormally off pixels among the on pixels. This may take place using the computer 14 shown in FIG. 1. Luminosity thresholds are then fixed below which or above which a pixel may be considered as being defective. A prior normalization of the luminosity of the pixel may also be made to correct variations affecting extensive parts of the screen.

Defective pixels may simply be counted, or they may be located by recording their coordinates in the final image.

### REFERENCE DOCUMENTS

(1) SHEKARFOROUSH Hassan, “Super-resolution en vision par ordinateur” (Super-resolution in computer vision), thesis at the University of Nice,

(2) Sean Borman, Robert L. Stevenson, Research Report, July 1998,

(3) Tsai and Huang, “Multiframe image restoration and registration” Advances in computer vision and image processing, vol 1, jai Press 1984,

(4) U.S. Pat. No. 5,764,209/WO-9319453, September 1998 Photon DYNAMICS: Flat panel display inspection,

(5) U.S. Pat. No. 5,771,068-1995 Orbotech: Apparatus and method for display panel inspection,

(6) JP-7083799/JP4016895, 31/03/1995 MINATO ELECTRON KK “Display element inspection system”,

(7) Sampling, aliasing and date fidelity, Gerald C. Holst, JCD publishing, SPIE Press, CH8., pages 199-218.

1. Process for checking a display screen comprising the following steps:
a) the screen (E) to be checked is controlled so as to display at least one test pattern with at least one spatial period P,
b) acquisition of a sequence of simple images (I) of the test pattern using an electronic camera (12) with a definition lower than the definition of the screen to be checked, the successive simple images being offset from each other,
c) construction of an over sampled image (S) of the test pattern starting from the simple images,
d) calculation of spectral components of the over sampled image using a first Fourier transform,
e) compensation of spectral alterations resulting from the previous steps by deletion and/or weighting of spectral components,
f) calculation of spatial components of a new image of the test pattern using a second Fourier transform of the spectral components resulting from step e),
g) analysis of the new image.

2. Process according to claim 1, in which one of the first and second Fourier transforms is made in an adapted manner by adjusting the spectral sampling pitch as a function of the spatial period P of the test pattern.

3. Process according to claim 2, in which a number of spectral samples N is adjusted such that the product Nτₛ is a multiple of the spatial period P of the test pattern, where τₛ is the spatial resolution of the over sampled image.

4. Process according to claim 1, in which the sampling pitch τₛ of the over sampled image is adjusted during step c) such that the product Nτₛ is a multiple of the spatial period of the test pattern, where N is the number of samples in the over sampled image participating in the calculation of the first Fourier transform.

5. Process according to claim 1, in which registration is done to substantially align the center of an image of the screen to be checked with the center of the camera and/or to make at least one edge of the image parallel to an edge of the camera and/or to compensate for optical distortion of an optical system (18) associated with the camera (12).

6. Process according to claim 5, comprising a deliberate display of several pixels with known coordinates in the test pattern to simulate defects and to form a registration system.

7. Process according to claim 5, in which registration takes place by calculation in step c), during construction of the over sampled image.

8. Process according to claim 5, in which screen pixels simulating defects on a row and/or a column of the test pattern with period P are controlled, and the phase of the spectral components is modified so as to make the spectrum phase recorded for the said row and/or column symmetric about a value ½P.

9. Process according to claim 1, in which the offset between successive simple images acquired in step b) of the process is not a multiple of the relative distance between two camera pixels.

10. Process according to claim 1, in which a test pattern is displayed on the screen and provided, in two directions x and y with periods Pₓ and P_{y}, such that
$$\frac{1}{{T}_{Rx}} - {ϵ}_{x} > \frac{1}{2 Px}$$
$$\frac{1}{{T}_{Ry}} - {ϵ}_{y} > \frac{1}{2 Py}$$
where T_{Rx} and T_{Ry} represent the dimensions of an integration window for a camera pixel and εₓ and ε_{y} are safety factors.

11. Process according to claim 1, in which step g) includes the localization of defective pixels in the new image.

12. Process according to claim 11, in which step g) includes a comparison of the intensity of the pixels of the new image with threshold values to localize abnormally on and/or abnormally off pixels.

13. Process according to claim 11, in which step g) comprises:
i) selection of a region in the new image surrounding a defective pixel,
ii) the calculation of spectral components in this region using a Fourier transform,
iii) adjustment of spectral components by adding a phase correction term tending to make the phase symmetric for the selected region,
iv) the calculation of new spatial components using a Fourier transform, to form a new image of the region,
v) creation of coordinates of the defect starting from the new image of the region.

14. Process according to claim 12, in which step g) includes adjustment of the phase by a value u=knπ/P, where k is a natural integer, and iteration of steps i) to iv) until the area in space of the defective pixel is minimized in the new image of the region.

15. Process according to claim 11, in which the coordinates of the defective pixels are established by a center of gravity calculation on adjacent pixels above or below predetermined luminosity thresholds.

16. Process according to claim 1, in which spectral harmonics are created by replication of the spectral components before step f).

17. Device for checking a display screen comprising:
means (14) of controlling the display screen (E) so as to display a test pattern on the screen,
means (18) of forming an image of the test pattern on an electronic camera (12) with a resolution less than the resolution of the display screen,
means (10, 20 22) of offsetting the image of the test pattern on the camera, and
means of analyzing (14) several offset images output by the camera to localize defective pixels on the display screen.

18. Device according to claim 17, in which the offset means comprise a positioning table (10) on which the screens (E) to be checked will be placed, and means (20) of making a relative movement between the table and the camera.

19. Device according to claim 17, in which the offset means comprise at least one transparent strip (22) with parallel faces installed free to pivot and associated with the image formation means.
